(19) United States
(12) Patent Application Publication
(10) Pub. No.: US 2009/0064029 A1
(43) Pub. Date: Mar. 5, 2009

(54) Methods of Creating and Displaying Images in a Dynamic Mosaic

(75) Inventors: F. Lee Corkran, Carlsbad, CA (US); Sean C. Davidson, Del Mar, CA (US); Billy Fowks, Brooklyn, NY (US)

Correspondence Address: Stephen B. Salai, Esq.;Harter Secrest & Emery LLP, 1600 Bausch & Lomb Place, Rochester, NY, 14604-2711, US

(73) Assignee: BRIGHTQUBE, INC., Carlsbad, CA (US)

(21) Appl. No.: 11/945,976

(22) Filed: Nov. 27, 2007

Related U.S. Application Data
(60) Provisional application No. 60/867,383, filed on Nov. 27, 2006.
(60) Provisional application No. 60/971,944, filed on Sep. 13, 2007.

(51) Int. Cl. G06F 3/048; G06F 7/06; G06F 17/30

(52) U.S. Cl. 715/781; 707/5; 715/825; 715/811; 707/E17.016

(57) ABSTRACT

A method of displaying a plurality of digital objects includes storing the plurality of objects in a database, associating fixed parameter metadata and dynamic metadata with each of the digital objects, and classifying each of the digital objects in the database based on at least one of the fixed parameter metadata and the dynamic metadata. A user search request is then received and a subset of requested objects is defined that correspond to the user search request. A relevancy value is computed for each of the subset of requested objects using the fixed parameter metadata and/or the dynamic metadata. The objects are then displayed on a user display such that the most relevant objects are presented to the user and less relevant objects are spaced from the most relevant object. The display maybe two- or three-dimensional and includes all relevant images in a single display.

### CROSS-REFERENCE TO RELATED APPLICATIONS

This application claims the benefit of U.S. Provisional Patent Application No. 60/867,383, filed Nov. 27, 2006, and U.S. Provisional Patent Application No. 60/971,944, filed Sep. 13, 2007.

### BACKGROUND OF THE INVENTION

1. Technical Field

The present invention relates generally to pictorial displays of search results. More specifically, the present invention provides a method of displaying results of a search of a database of digital content.

2. Description of Related Art

Network delivered services for searching and retrieving digital content have functionally evolved to support the expanding use of digital objects in a variety of applications, many driven by new applications on the internet. Stock photography services, which allow for the purchase, license, and/or download of digital photographs on the Internet, are an example of such applications. In these applications, a user searches a catalog of photographs using search terms, and the results of the search are presented to the user as a group of small, thumbnail pictures or graphic icons arranged in columns and/or rows. For ease of processing, when numerous search results are retrieved, conventional applications display a predetermined, or configurable number of the thumbnail images per page. Often, text or other data accompanies the images. Thus, to browse through all of the pictures, a user must move forward and backward among numerous pages to find the photographs they would like to ultimately, license, purchase or download.

A significant shortcoming of these conventional applications, however, is that this results that best fit the searchers needs are not seen if those images are not indexed such that they happen to appear in the first few pages of results. This is particularly true because users interpret the search parameters of an object in so many ways that it is difficult to add metadata that supports search by a wide and varied user community.

In addition to having shortcomings for a user, conventional stock photography applications also have drawbacks for photograph providers. Namely, as a photographer's photographs are relegated to later and later pages, their likelihood of being seen, and therefore purchased, is minimal.

Accordingly, there is a need in the art for an improved method of displaying graphical search results. There also is a need in the art for displaying a large number of graphical images in a condensed space. There also is a need in the art for a method of displaying graphical images in response to a user search with the results most relevant to the user being more prominently displayed. There also is a need in the art for a method of searching and displaying graphical images that allows for manipulation and refinement of the search results.

### SUMMARY OF THE INVENTION

This invention remedies the foregoing needs in the art by providing an improved method of displaying graphical images to a user.

In one aspect of the invention, a method of displaying a plurality of digital objects includes storing the plurality of objects in a database, associating a plurality of attributes with each of the plurality of objects, and classifying each of the plurality of objects based on the associated attributes. A user search request is then received, and a subset of requested objects from the plurality of objects in the database that correspond to the user search request is defined. Each of the requested objects is assigned a relevancy value defining the relevancy of each of the requested objects to the user search request. The relevancy value incorporates the classification of each of the objects based on the associated attributes. All of the requested objects are then displayed in a matrix, with the requested object having the highest relevancy value displayed proximate a center of the matrix, and requested objects having successively lower relevancy values displayed spatially outwardly from the requested object having the highest relevancy. The entire matrix is viewable by the requester through zoom and pan navigation controls.

In another aspect of the invention, another method of displaying digital objects in a display matrix includes storing a plurality of digital objects in a database, associating metadata with each of the plurality of digital objects, the metadata comprising textual elements and properties of the digital object, receiving a search request from a user comprising a textual search term, defining a resultant subset of the plurality of digital objects, each of the resultant subset having metadata related to the textual search term, computing a relevancy value of each of the resultant subset using the metadata of each of the objects in the resultant subset, and displaying the objects in a matrix ordered according to the computed relevancy value.

An understanding of these and other features of the invention may be had with reference to the attached figures and following description, in which the present invention is illustrated and described.

### BRIEF DESCRIPTION OF THE DRAWING FIGURES

FIG. 1 is a schematic diagram of a system for implementing the methods according to preferred embodiments of the invention.

FIG. 2 is an example user interface for entering a search query according to preferred embodiments of the invention.

FIG. 3 is a screenshot of a matrix generated as a result of a search in a preferred embodiment of the invention.

FIG. 4 is a graphical depiction of a matrix created using tiling according to a preferred embodiment of the invention.

FIGS. 5A-5F are representative displays according to preferred embodiments of die invention.

FIG. 6 is a screenshot of a matrix generated as a result of a search in a preferred embodiment of the invention.

FIG. 7 is a screenshot of a matrix with one of the elements comprising the matrix selected.

FIG. 8 is a screenshot of a “lightbox” according to a preferred embodiment of the present invention.

FIG. 9 is a flow chart of a preferred method of the present invention.

### DETAILED DESCRIPTION OF THE INVENTION

The present invention how will be described with reference to the figures

As noted above, the present invention relates generally to a user interface used for searching a database of digital content and displaying graphically the results of the search. More specifically, the results preferably include a graphical depiction of the digital content retrieved by the search. For example, when the database contains photographs, a user can search a collection of photographs stored in a database and obtain search results in the form of thumbnail depictions of the photographs. In another example, when the database contains digital videos, a user can search the digital videos and obtain search results in the form of representative images indicative of the digital videos. The representative images could be the first frame or some other frame that better represents the digital video or something else all together. The invention is not limited to these examples, but can be used to search any digital content contained in a database, as will be appreciated by the following discussion. However, for the sake of clarity, the preferred embodiments will be described using the example of a database containing a plurality of photographs or digital images.

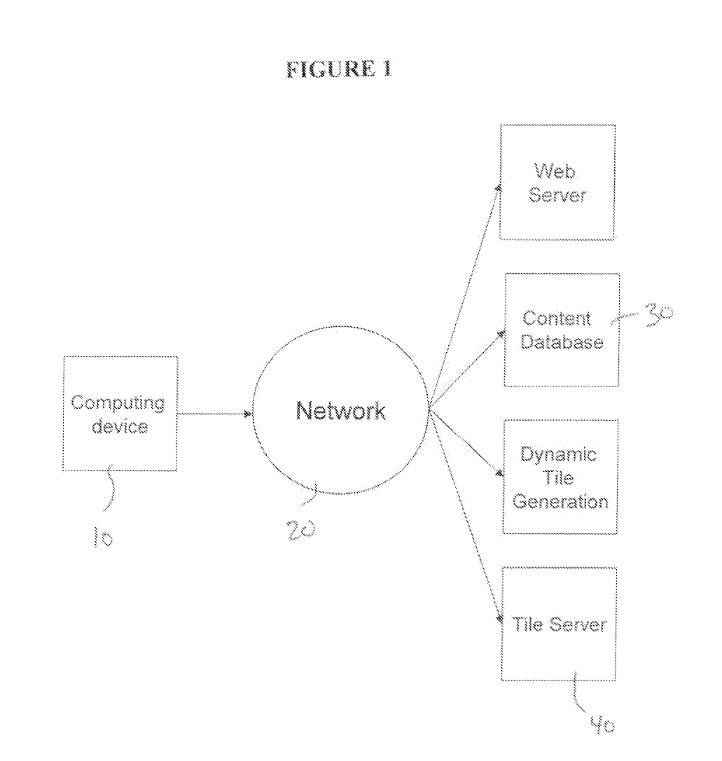

As illustrated in FIG. 1, a system according to the invention generally includes a computing device 10 or similar user interface. The computing device may be a personal computer, a specialized terminal, or some other computing device. The device preferably accepts user inputs via some peripheral, e.g., a mouse, a keyboard, a touch screen, or some other known device. The computing device 10 is connected to a network 20, which may include the Internet, an intranet, or some other network. The network 20 preferably has access to a content database 30, which stores the digital images in the preferred embodiment. More than one database may also be used, e.g., each storing different types of content or having different collections. A tile server 40, which will be described in more detail below, may also be connected to the network.

Each of the digital images contained in the database preferably is stored with a representative image, or thumbnail, and associated attributes, or metadata. As used herein, metadata generally refers to any and all information about the digital object. Tire metadata preferably includes information associated with each image at any time, namely, at image creation, when the image is uploaded to the database, and after the image has been uploaded to the database. The metadata preferably also includes fixed parameter metadata and dynamic workflow metadata.

For example, metadata that may be created at image creation may include, for example, a file size, a file type, physical dimensions of the image, a creation date of the image, a creation time of the image, a recording device used to capture the image, and settings of the recording device at the time of capture. Examples of metadata associated with the image at the time of upload to the database may include a date on which the image was uploaded to the database, keywords associated with the object, a textual description of the object, pricing information for the object. Metadata created after upload may include a rating applied by users, a number of times that the image is viewed by a user, shared with another, downloaded, or purchased, the date and time of such occurrences, or updated keywords or descriptions. Fixed parameter metadata generally refers to data intrinsic to the image, for example, source of die image, size of the image, etc., while dynamic workflow metadata generally refers to extrinsic data accumulated over time, for example, a number of times an image is purchased or viewed or a rating given to the image by viewers.

The dynamic workflow metadata may also be unconscious or conscious, i.e., the metadata may be gleaned from user interaction at the computing device without the knowledge of the user (unconscious), or the metadata may be directly solicited from the user (conscious). Examples of unconscious dynamic metadata include the number of times the image is in the result set of a search, where that element was in order of relevancy in that search, whether the image was viewed/previewed/used/purchased by the end user, the length of time for which the image was viewed/previewed/used, the number of times the image was viewed/previewed/used/purchased, whether the item was scrutinized, whether the element was placed into or removed from a lightbox, whether the image was returned, and information about the user (e.g., number of times using the application, country of origin, purchasing habits, and the like). Conscious metadata may include ratings given to images by a user, the application of private keywords as tags, rating of existing keywords or categories, creating custom personal collections of images, and the application of notes or text or URL references to elements for added context. The foregoing are only examples of metadata, arid are not limiting.

The same types of metadata preferably are maintained for each of the images contained in the database, and these types of metadata may be directly searchable by a user. For example, a user may search for all images from a certain source or having a certain file type. However, when increasingly large numbers of images are maintained in the database, directly searching the metadata may yield an extraordinary amount of results, or may result in slow processing. Accordingly, each of the images preferably is classified based on the metadata and this classification is stored. For example, when the metadata in question is file size, predetermined thresholds may be established to define a number of ranges within known file sizes and a table is created with this information. All images having a file size that is one Megabyte or less may have a first classification in the table, all images having a file size greater than one Megabyte and less than two Megabytes may have a second classification, etc. In this manner, the images are separated in the database in subsets of different file sizes. Similarly, the images can be separated into additional subsets for additional metadata types. As a result, each object includes an identification based on where each piece of its associated metadata is ranked or classified. The now-classified metadata are then combined together to create an identifier for each of the digital images. The identifier may be a string of numerals, with each position in the string representing a different type of metadata. The identifier preferably is stored in the database with the original image. The combined metadata, or the individual pieces of metadata, may alternatively be stored in a separate database, or it may be contained in a look-up table stored in the same or a different database.

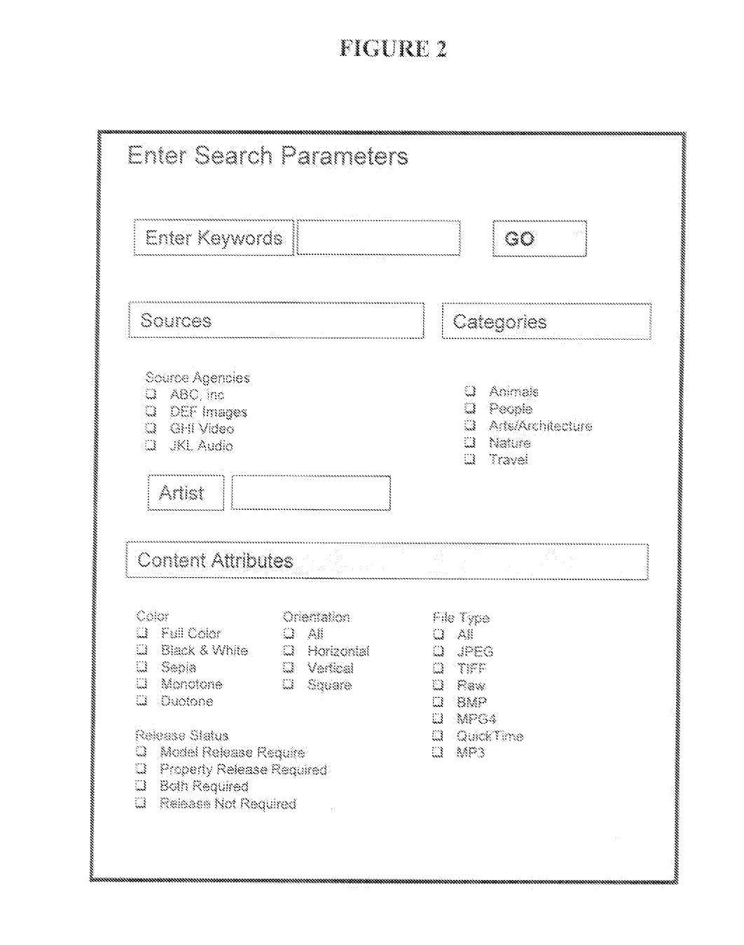

When a user inputs a search request into the user interface, for example, using a search request screen such as that shown in FIG. 2, the request is transmitted via the network to the database to obtain a subset of images that correspond to the search request. The database and user interface preferably are constructed such that a single call from the application to the database is all that is required, with a list of image IDs in order of relevancy to the search criteria being returned to the application at the user interface. For example, SQL may be used to interface with the database.

Several optimizations maybe used to speed up response times. For example, arid as described above, the images are preferably pre-separated into subsets all of which need not be searched. For example, images may be classified as professional or amateur, with only a single subset being searchable at a time. Thus, roughly half of all the images need be searched for each query. Presence of keywords to be searched also is determined as well as other input parameters. By increasing the search terms, the “correct” set of search tables is selected and a query e.g., an SQL query is dynamically constructed to retrieve the image IDs (and their relevancies, as will be described in more detail, below).

For example, a user may search for all images within a price range, having a certain size, and created on a certain day. This may yield a relatively small number of images that have metadata corresponding to the search terms (as learned by comparing the search result to the identifier). The resulting images are displayed for viewing by the user.

When the search terms correspond to fixed parameter metadata, the images will either have the requested terms (or be within a requested classification range) or they will not. In the example given above, the display may include only those images that match all of the price range, size, and creation date. Alternatively, the images containing all three attributes may be most prominently displayed with image matching two of the three criteria secondarily displayed, and those images matching one of the three criteria thirdly displayed. These settings may be dictated by the application provider, or may be user-selected.

A user may also input one or more textual search terms into the search request screen to query the database. The search term(s) preferably is checked against metadata of each of the pictures, the metadata including the title, related keywords, and/or a textual description of each image. The search of all the images would result in a subset of images that correspond in some way to the search term. Specifically, the search term may reside in one, two, or all three of the title of the image, the keywords and/or the description. When the results are displayed to the user, the images that have the search term in the title, the keywords and the description may be displayed most prominently, with images having the search term in two of the three fields displayed secondarily, and images having the search term in only one of the fields displayed thirdly. Within each of the second and third layers, the title, keywords, and description may be weighted differently, with die heavier-weighted results being displayed more prominently. For example, it may be established that correspondence of a search term to the keywords is more meaningful than correspondence of the search term to a word in the description. Accordingly, images having the search term in the keywords will be displayed more prominently than those having the search term in the description.

As should be understood, when numerous results are returned from a search request, it is desirable that more relevant images be more prominently displayed than those that may have only slight relevance. The number of matching search terms or weighting of certain metadata, discussed in the previous examples, are ways to define relevance of images within a set of images. The present invention also contemplates other methods of defining a relevance value based on the metadata associated with each image that defines the order in which images are displayed to a user also may be used. Such methods are particularly useful when a user search returns a large number of images having substantially the same metadata.

The relevancy value preferably is calculated using fixed parameter metadata, unconscious dynamic workflow metadata, and conscious dynamic metadata. Because the relevancy value incorporates dynamic metadata (both conscious and unconscious), the display of images is constantly evolving, and the display is dynamic. With increased workflow, i.e., more data from user interaction, the relevancy of images changes, and therefore which images are more relevant changes. Accordingly, two searches for the same search parameters at different times likely will result in a different display of images, based generally on user interaction with the application and dynamic metadata gleaned from such interaction. For example, if users rate items more favorably, or users view certain images more frequently, or purchase certain images more regularly, those images may be considered more relevant, and thus displayed more prominently. Conversely, if an image has been previously relatively prominently displayed, but was ignored or if an image is repeatedly scrutinized by viewers, but is never purchased; these images may be deemed less relevant for future searches.

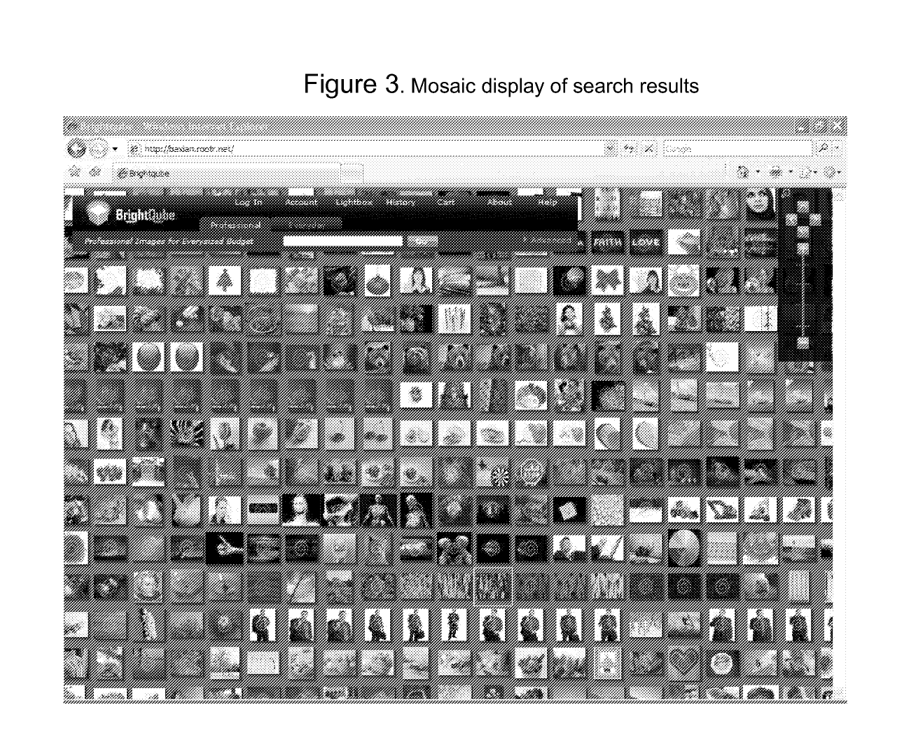

In a preferred embodiment of the invention, a matrix is provided that contains all of the images that are retrieved from the database as a result of the user search, and the matrix employs the relevancy value for each of the images to determine the ordering of the images. This is particularly different from prior art applications in which only a first number of images are displayed on a first page, with subsequent images being displayed on subsequent pages. In the preferred matrix of this invention, which supplies all of the returned images, the number of images is often too cumbersome to be displayed in the viewing area of the computing device. Thus, the images preferably are displayed on the viewing device, but also are contained outside of die field of view of the user. Put another way, only a portion of the matrix is viewable at a given time because the matrix is larger than die viewing display. When only a portion of the matrix is displayed to a user, the matrix preferably may be navigated by a user, for example, by panning and zooming throughout the entire matrix. A sample matrix 70 is illustrated in FIG. 3, with conventional word navigation tools 80 provided for panning and zooming.

Because only a portion of the entire matrix may be viewed by the user at a time, it is desirable to place the most relevant images in the portion of the matrix that is first presented to a user. In the preferred embodiment, the image with the highest relevancy value (as calculated as described above) preferably is displayed in the center of the matrix, and the center of the matrix is presented to the user as an immediate result to the users search. With the most relevant image displayed in the center, images having increasingly less relevance are displayed spatially outwardly from the center. The images maybe formed as a spiral formed either clockwise or counterclockwise from the central, most relevant image. Alternatively, levels of relevancy may be provided with the next least relevant images being provided in a second level that is a first concentric ring around the center image and subsequently less relevant images being displayed as additional concentric rings further spaced from the center, most relevant image. As illustrated in FIG. 3, the results preferably are shown as graphical representations only i.e., tree. In most instances, a “thumbnail” version of the actual digital image is displayed in the matrix, which preferably is a smaller file size having lower resolution. Other methodologies for displaying the images also are contemplated. Specifically, the most relevant image could be placed anywhere in the matrix with less relevant images arranged in some order. For example, the most relevant image could be placed in the upper-left corner, with the remaining images ordered to the right and below the most relevant image.

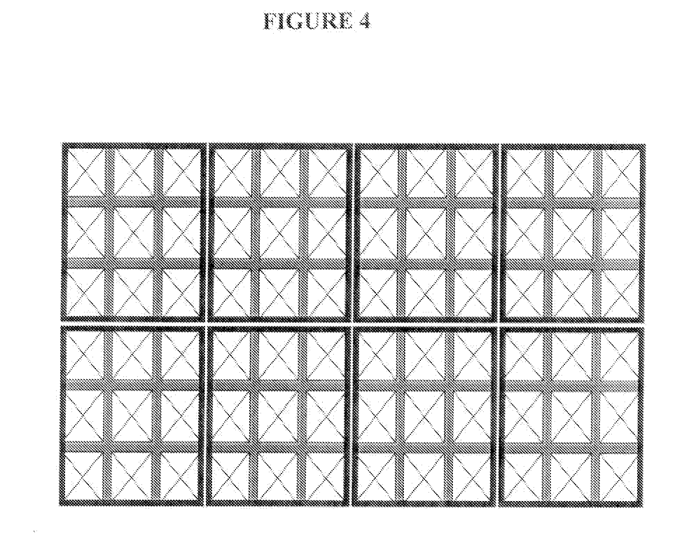

In one implementation of die present invention, a grid is created that will represent the matrix, with the grid being subdivided into tiles, or smaller matrices. An example of this is illustrated in FIG. 4, in which the matrix 70 includes eight tiles 74. Each of the tiles has a number (line, in the example) of chips 76 each of which preferably comprise a thumbnail image representing the stored digital image. For each tile 74, a request is constructed from a tile server to fulfill. The request may be sent to the tile server 60 in the form of a URL in the network, e.g. through a user's web browser. More particularly, the web browser, would provide a list of image ID's to the file server which would find the corresponding thumbnail images and provide them to the browser. Several request may be made to the file server to populate each dynamic mosaic. In a preferred embodiment, the file server is a web server that is specialized to serve files for dynamic file generation.

As noted above, the chips in each tile preferably are arranged in a spiral from the center with the center-most chip being the most relevant. The ordering of the chips in each tile preferably is set in the application at the user interface. The ordering of requests to fill the tiles preferably also is established by the application at the user interface. Preferably a tile containing the most relevant hits is requested first, but such is not required. Any order could be used. Alternatively, only those tiles that will be viewed (entirely or partially) on the user display may be requested. In yet another embodiment, the tiles adjacent to those that are viewed also may be requested, such that the application is ready to display those tiles when a user pans in any direction.

Thus, according to the invention, the most relevant images, as determined by the relevancy factor, are prominently displayed to a user, with increasingly less relevant images being displayed increasingly farther from the most relevant results. Nevertheless, all images having any relevance at all preferably are displayed in a single matrix in graphical form. In this way, a user can easily pan over or otherwise navigate the matrix to view any images that have some relevance to the search query. As noted above, when a user selects or otherwise views an image, that selection or viewing may update dynamic metadata, which could result in the selected or viewed image being more highly relevant to the user's search query the next time that query is made.

Other methods for displaying the images also may be used. For example, associations may be made between images; such that additional relevant subsets of images may be displayed adjacent the most relevant image in response to a user search. For example, a search result for the term “tree” may include in the center of the matrix images showing trees, while subsets of images may be provided throughout the matrix. For example, one subset may be shown that includes only cherry trees, one showing oak trees, and yet another showing lumber. These subsets of images may be grouped based on their associations and will be displayed Outwardly from the center, most relevant results of die search request. Each of the subsets preferably includes a tile or segment of the matrix comprising a number of the search results.

These subsets maybe pre-established, for example, the keyword oak could be predetermined to be related to tree, and thus an “oak” subset may come up every time a user searches for the term “tree.” Other types of image processing may also be done to “pre-process” the images, with the goal of obtaining more relevant search results. For example, metadata associated with images may includes searchable histographic analysis profiles, image/video frequency fingerprints, element/object content, geo-spatial analytics, temporal-spatial analytics, colorimetric matching profiles, sequencing data, and/or optical flow characteristics. Some of these image subsets will be pre-established, while other will be established over time, i.e., using dynamic metadata. For example, when users continually group, compare, or successively select two or more images, those images may become associated, such: that they form a subset that occurs in certain matrices to which the subset is related. This type of unconscious dynamic workflow metadata may create an association, although that association would not necessarily be made by someone uploading images to the database.

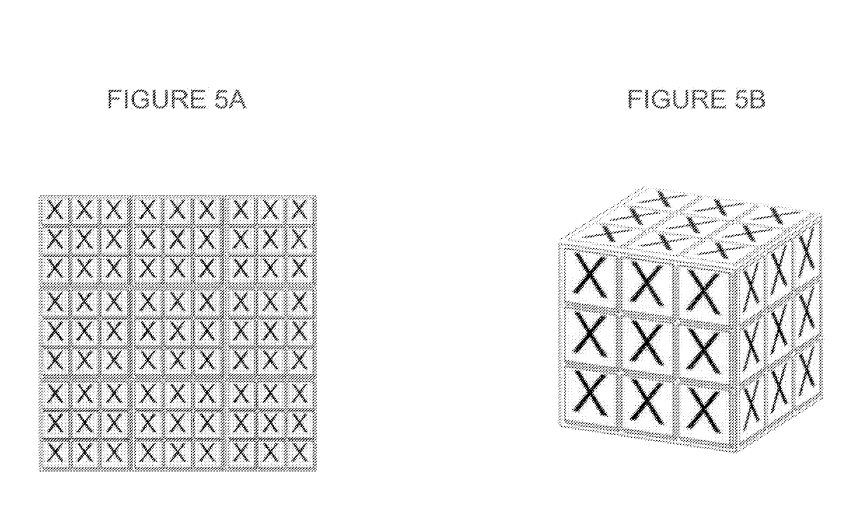

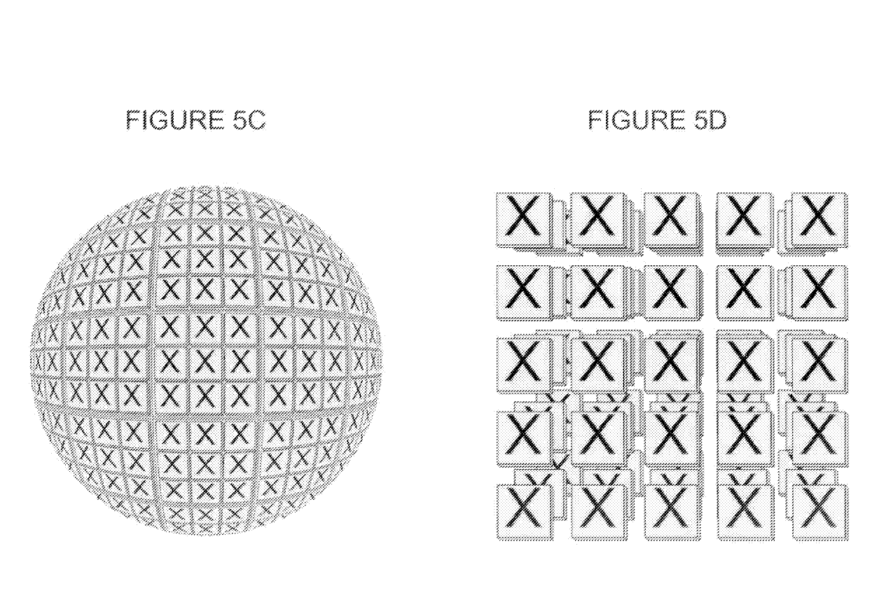

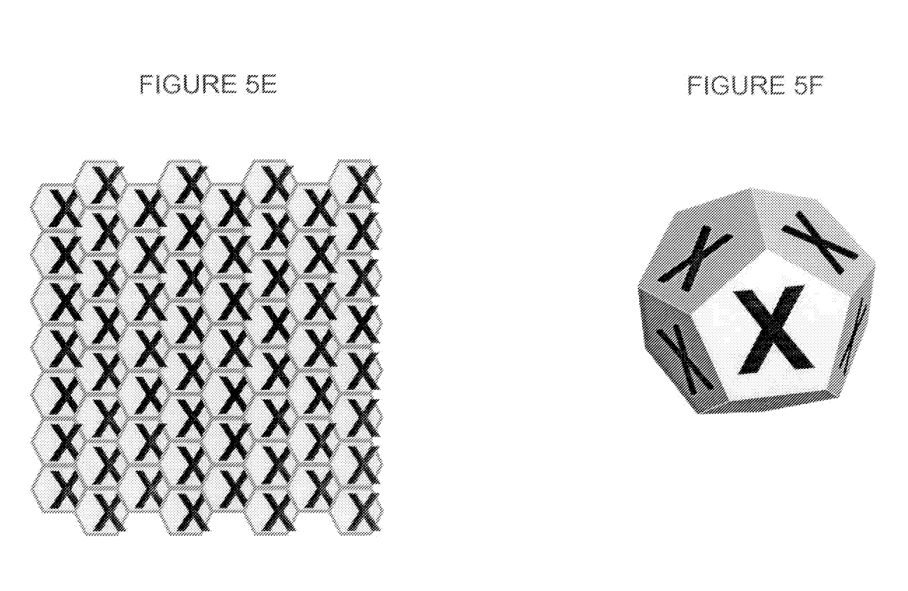

The matrix displayed to the user preferably is two dimensional, with the images displayed in rows and columns, as shown in FIGS. 3, 4 and 5A. However, the invention is not limited to this implementation. For example, the images may be displayed diagonally or along curves in the two dimensional plane. The images also may be cropped into triangular, hexagonal or any other shape arid displayed. Alternatively, the images may be displayed in three or more dimensions. For example, it is contemplated that the images could be displayed in a cube that appears to be three dimensional, and is manipulatable by the user. For example, the subsets of tiles described above may be displayed on faces of a cube. Alternatively, the most relevant images may be displayed on a two-dimensional plane, with the next most relevant images displayed on a second, parallel, plane, arid successive levels of relevant images displayed on other parallel planes. Other three dimensional renderings, such as, but not limited to spheres, cylinders or polyhedra may also be used to create varied user experiences. FIGS. 5B-5F illustrate exemplary displays. Specifically, those figures represent a cubic; display, a spherical display, a multi-tiered display, a hexagonical grid display, and pentagonal dodecahedron, respectfully. In the preferred embodiment, the user can select the display format.

Regardless of the shape of the mosaic, and the manner in which the images are displayed to the user, the entire mosaic is navigatable by the user, using for example, pan and zoom techniques known in the art. These techniques may include, “grabbing and moving” the mosaic with a pointing device, using arrow keys, or using a control button provided on the display. Sliders and the like also may be provided on the display. Similarly, zooming features can be embodied using a slider mechanism, a wheel on the mouse, or other known means. When more than two dimensions are provided, additional adjustments may be necessary, for example to, alter die angle at which the observer perceives the field of results in the mosaic.

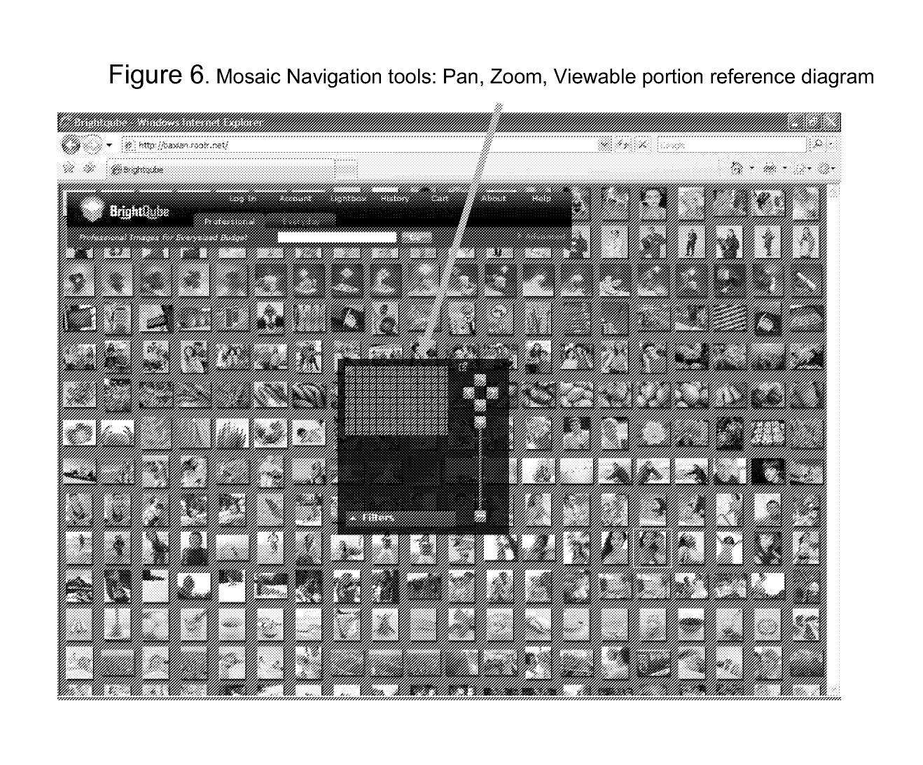

The present invention provides a specific improvement upon the conventional art by displaying all images returned during a search result as thumbnail images in a single mosaic, with the most relevant search results being displayed most prominently in die mosaic. The inventors have found that by providing all the images, a much easier and more user friendly experience is provided, because the eye can more quickly discern between the images, even when they are provided as thumbnail images, without the need to browse through multiple pages of images. Preferably, and as illustrated in FIG. 6, also included at the user interface, is a reference view 80 of the entire matrix. For example, a minimized display of the matrix is provided in the user's viewing area, i.e., over the matrix, with some indication of the portion of the matrix currently being viewed by the user. Accordingly, the user will have a better idea of the number of results obtained and the portion of those results that are currently being viewed, and can more readily determine which images have already been viewed and which still need be looked at.

Additional controls also preferably are provided to the user. These controls may include user interface widgets, such as slider bars. Each of the provided widgets preferably is associated with a metadata type associated with each of the images to allow a user to further filter or refine the search results. In this manner, once a search result is defined, the result of that search may be refined by limiting certain parameters. For example, if a user is looking for images that are only of a specific file size, the sliders may be provided to remove any images not within those parameters. Similar user interface mechanisms also may be provided to filter images based on other metadata. Once refined, the matrix regenerates to display the upgraded results.

Still other interface mechanisms may be dynamically provided during a search. For example, if a user conducted a search for trees, it may become clear to the user that they wanted trees with a certain color of leaf and/or a certain “plushess” of the tree. A user may be able to select color to sort by, with all images being arranged in some color order, and leaf density may also be discerned, e.g., by determining an amount of a leaf-color within each color range. The results may be provided in a typical 2-dimensional image plane with the reddest leaves on the left becoming greener to the right, and the sparsest trees to the top becoming denser toward the bottom.

As should be appreciated, the results of the search may be better or worse depending upon the amount of preprocessing that is done with images, which will dictate upon the amount of metadata associated with each of the images. Relevancy also will be further refined by continued use of the search tools by users. The dynamic workflow metadata will only become more valuable with continued use. For example, as a certain image is purchased more and more, that image's relevancy will continue to increase, causing that image to be more prominently displayed. The logic being that as the image is purchased more, it is more desirable than other images having similar metadata. Which properties are more relevant than others may be built into the application, or may be selectable by a user. The results may also be useful to the content provider. In one instance, the content provider may realize that one of its images has been reviewed numerous times, but has never been purchased. This could provide insight to the content provider as to what is desirable and what is not in photographs and other images. By monitoring, collecting and using the dynamic workflow data, more and more information is obtained to provide a more detailed and meaningful search to the user.

Thus, the invention uses taxonomy, which is the characterization, classification, and ordering of information based on its use over time. This data is easily tracked using known methods. Moreover, the invention preferably uses folksonomy, which is the application of collective tagging of objects by the user community. For example, the end user may be able to rate images using known methods. Finally, the invention also considers fixed parameter information, which is set for each image. Thus, a robust methodology is provided that creates a highly-interactive, easy-to-use display. Preferably, it is the use of the fixed perimeter metadata, the dynamic workflow metadata and conscious dynamic tagging, which includes both folksonomy and taxonomy that provides the most useful search results to an end user.

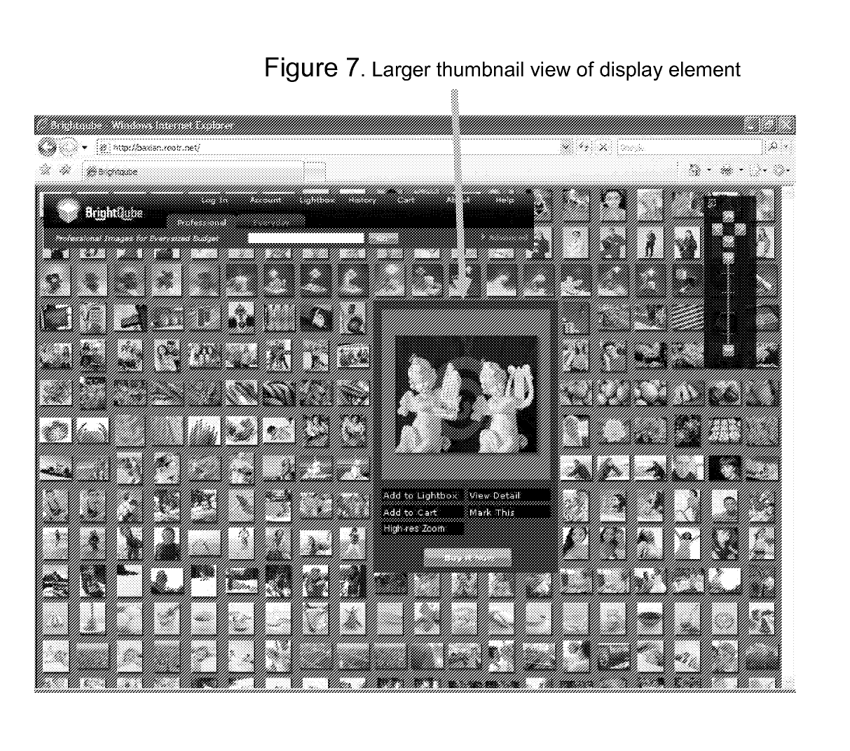

Because the images are preferably displayed as thumbnail images, the apparatus and methodology of the present invention preferably also include instrumentation for a user to more clearly view an image prior to purchasing. For example, images within the mosaic may be “clicked-on” or otherwise selected using known methods to enlarge the thumbnail, or to open a separate browser window with the image in a zoomed-in format. Selecting a thumbnail preferably also causes textual information about the image to be displayed. For example, the title of the image, the price for purchasing the image, or other data about the image (likely corresponding to some type of associated attribute or metadata) may be displayed adjacent the enlarged image. Action that may be taken with respect to the image also may be shown. An enlarged, selected image is shown in FIG. 7.

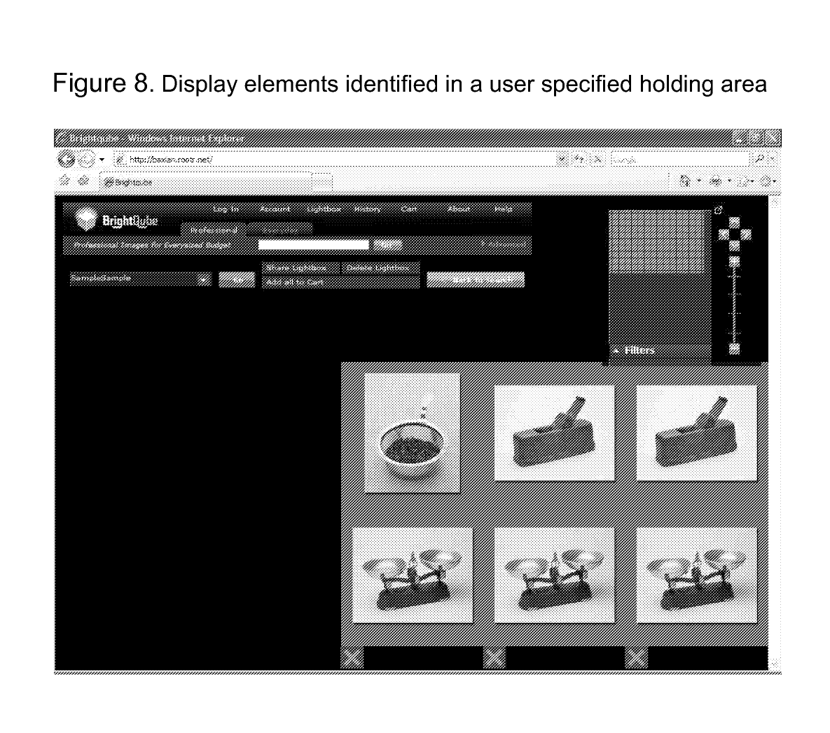

Another feature of the invention is the use of a separate area, called a “lightbox,” in which the user can place copies of select images for further processing, purchase, sharing, or comparison. An exemplary lightbox is illustrated in FIG. 8.

The present invention preferably also provides additional zoom tools that will allow a user to view some or all of the image at full resolution, prior to purchase. It is likely preferable, however, that the entire image not be viewable at full resolution, for fear of illegal copying. Accordingly, the present invention preferably only allows for zooming of parts of the image to full resolution without payment. Alternative anti-piracy safeguards also maybe employed, such as, for example, watermarking the image, or the like.

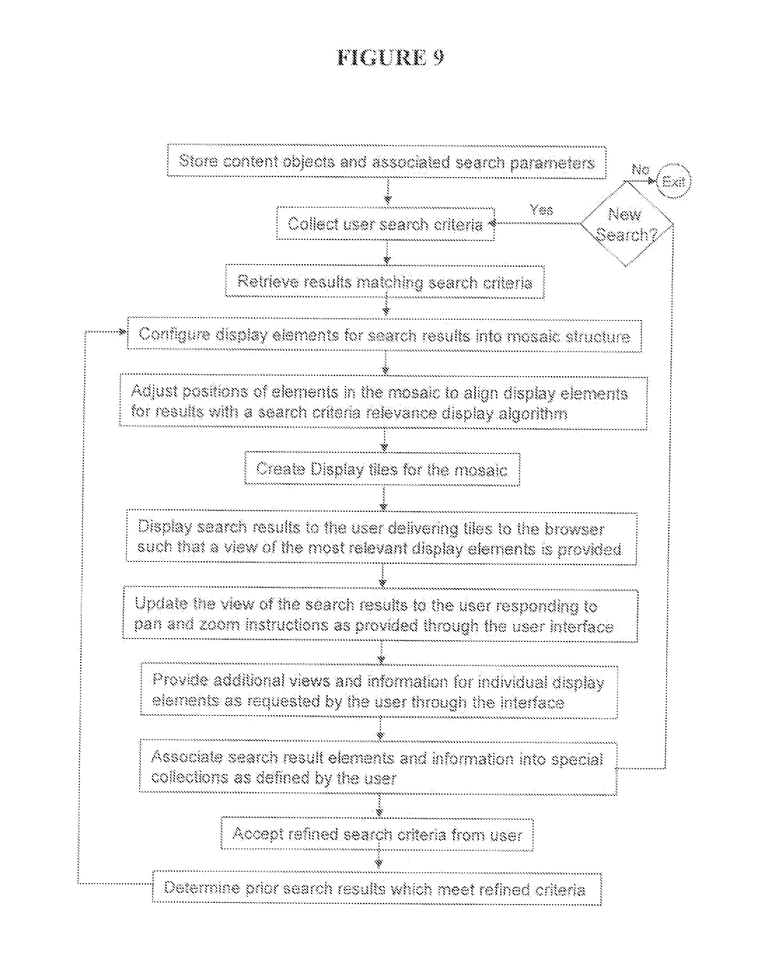

Thus, the present invention provided improved methods for presenting images to a user. Another preferred method, similar to the methods described above also is illustrated in FIG. 9.

The foregoing embodiments of the invention are representative embodiments, and are provided for illustrative purposes. The embodiments are not intended to limit the scope of the invention. Variations and modifications are apparent from a reading of the preceding description and are included within the scope of the invention. The invention is intended to be limited only by the scope of the accompanying claims.

We claim:

1. A method of displaying a plurality of digital objects, comprising the steps of:
storing a plurality of objects in a database;
associating a plurality of attributes with each of the plurality of objects;
classifying each of the plurality of objects based on the associated attributes;
receiving a user search request;
defining a subset of requested objects from the plurality of objects in the database that correspond to the user search request;
assigning each of the requested objects a relevancy value defining the relevancy of each of the requested objects to the user search request, the relevancy value incorporating the classification of each of the objects based on the associated attributes; and
displaying all of the requested objects in a matrix, with the requested object having the highest relevancy value displayed proximate a center of the matrix, and requested objects having successively lower relevancy values displayed spatially outwardly from the requested object having the highest relevancy.

2. The method of claim 1, further comprising providing a user interface corresponding to one of the associated attributes, the user interface being operable by a user to refine the subset of requested objects; and
displaying a refined matrix containing the refined subset of requested objects with the requested object having the highest relevancy value displayed proximate a center of the matrix, and requested objects having successively lower relevancy values displayed radially outwardly from the requested object having the highest relevancy.

3. The method of claim 1, wherein the requested objects are grouped in the matrix according to a pre-defined attribute.

4. The method of claim 1, wherein the relevancy value comprises information about one or more of the associated attributes.

5. The method of claim 1, further comprising updating the plurality of attributes based on user interface with the matrix.

6. The method of claim 1, wherein the requested objects are grouped in the matrix according to common attributes.

7. The method of claim 1, wherein the matrix is larger than the display area of a user display.

8. The method of claim 7, further comprising providing a graphical representation of the entire matrix in the display area of the user display.

9. The method of claim 8, further comprising indicating in the graphical representation of the entire matrix a portion of the matrix currently displayed in the display area.

10. The method of claim 1, wherein the matrix is a multidimensional matrix.

11. The method of claim 10, wherein the matrix is one of two-dimensional and three-dimensional.

12. The method of claim 11, wherein the matrix comprises a plurality of matrices, each formed on a face of a three-dimensional object.

13. The method of claim 1, wherein the matrix comprises a number of tiles, each tile comprising a number of digital objects.

14. The method of claim 1, wherein the associated attributes-comprise at least one of fixed parameter metadata, dynamic workflow metadata, and dynamic tagging.

15. A method of displaying a plurality of digital objects comprising the steps of:
providing a plurality of digital objects in a database;
associating fixed parameter metadata and dynamic metadata with each of the digital objects;
classifying each of the digital objects in the database based on at least one of the fixed parameter metadata and the dynamic metadata;
receiving a user search request;
defining a subset of requested objects from the plurality of objects in the database that correspond to the user search request by retrieving all digital objects having a classification comporting with die search request;
computing a relevancy value for each of the subset of requested objects using at least one of the fixed parameter metadata and dynamic metadata; and
displaying the objects on a user display in an order determined by the relevancy value of each of the subset of requested objects.

16. The method of claim 15, wherein the images are displayed in a matrix with the most relevant image, as determined by the relevancy value, displayed for viewing by the user.

17. The method of claim 16, wherein the most relevant image is displayed in a center of the display device with successively less relevant images, as determined by the relevancy values of those images, spaced increasingly outwardly of the center, most relevant image.

18. The method of claim 15, further comprising updating the dynamic metadata with user interaction.

19. The method of claim 18, further comprising soliciting the user interaction.

20. The method of claim 15, further comprising providing at least one user interaction tool on the display screen that is manipulatable by the user to further refine the displayed objects; and
re-displaying the matrix in response to manipulation of the tool by the user.

21. The method of claim 20, wherein the user interaction tool corresponds to a type of one of the fixed parameter metadata arid the dynamic metadata.

22. The method of claim 15, further comprising associating a group of digital objects based on like classifications and displaying the entire group of associated digital objects in the display step.

23. The method of claim 22, wherein the results are displayed in a matrix and the group of associated digital objects is displayed in a portion of the matrix.

24. The method of claim 15, wherein the dynamic metadata associated with a representative object comprises at least one of a number of times the representative object has been viewed, a length of time for which the representative object was viewed, the number of times the representative object has been purchased, and a user rating of the representative object.

25. The method of claim 15, wherein the display is one of a two-dimensional display and a three-dimensional display.

26. The method of claim 25, wherein the three-dimensional display comprises one or more digital objects on each face.

27. The method of claim 15, wherein the relevancy value is further defined by associations between objects.

28. The method of claim 27, wherein the association is formed as a result of user interaction with the results displayed in the display step.

29. The method of claim 15, further comprising associating one of keywords and a textual description with each of the plurality of objects and wherein the user search request includes textual search terms, with the resulting display including objects having the textual search in common with one of the keywords and textual description.

30. The method of claim 29, wherein the relevancy value comprises information about whether the textual search terms correlate to the keywords and textual description.

31. A method of displaying digital objects in a display matrix, comprising the steps of:
storing a plurality of digital objects in a database;
associating metadata with each of the plurality of digital objects, die metadata comprising textual elements and properties of the digital object;
receiving a search request from a user comprising a textual search term;
defining a resultant subset of the plurality of digital objects each of the resultant subset having metadata related to the textual search term;
computing a relevancy value of each of the resultant subset using the metadata of each of the objects in the resultant subset; and
displaying the objects in a matrix in accordance with the computed relevancy value.
